(19) United States
(12) Patent Application Publication
(10) Pub. No.: US 2003/0083202 A1
(43) Pub. Date: May 1, 2003

(54) Roots-inducing agent of plants and its treatment method

(76) Inventors: Masato Katayama, Nagoya-shi (JP); Eiji Kageyama, Seki-shi (JP)

Correspondence Address: Lorusso & Loud, 440 Commercial Street, Boston, MA, 02109, US

(21) Appl. No.: 09/931,193

(22) Filed: Aug. 15, 2001

(51) Int. Cl. A01N 43/36

(52) U.S. Cl. 504/284

(57) ABSTRACT

To offer the convenient roots-inducing agent of plants capable of inducing roots of plants without roots, made by a cutting into cultivation soil so as to make the plants take root efficiently and its treatment method to induce roots of plants. A solution including a compound (or compounds) among those shown as in the following formula:

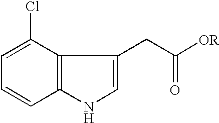

(Compound I, in which R means one of alkyl- and allyl-groups of hydrogen, methyl, ethyl 1-propyl, 2-propyl, 1-butyl, isobutyl, 2-butyL (R)-2-butyl, (S)-2-butyl, tert-butyl, and 1-pentyl), and a roots-inducing agent of plants characterized by its ability to induce roots of plants without roots made by a cutting into cultivation soil through its spraying onto the surface of the leaves, and the method to induce roots of the corresponding plants characterized by inducing roots of plants without roots made by a cutting into cultivation soil through the spraying onto the surface of the leaves the given roots-inducing agent of plants

### BACKGROUND OF THE INVENTION

1. Field of the Invention

The present invention relates to a convenient roots-inducing agent of plants capable of inducing roots of plants without roots made by a cutting into cultivation soil so as to make the plants take roots efficiently, and to its treatment method to induce roots of plants.

2. Description of the Related Art

Indole-3-butyric acid (Commercial name: Oxyberon) and α-naphthalene acetamide (Commercial name: Rooton, Transplanton) are on the market as a roots-inducing agent of plants. Also, esters of 4-chloroindole-3-acetic acid have been disclosed in Japanese Unexamined Patent Publication No. 9-241239 official gazette and derivatives of dichloroindole-3-acetic acid have been disclosed in Japanese Unexamined Patent Publication No. 6-62563 official gazette.

On the other hand, indole-3-acetic acid and its derivatives are known as a native endogenous auxin. Also, 4-chloroindole-3-acetic acid has been isolated from pea immature seed. It is known that the compound has a potent auxin activity and its activity is continuous because of its stability to the enzymes such as peroxidase.

### SUMMARY OF THE INVENTION

However, indole-3-acetic acid and its derivatives and indole-3-butyric acid and its derivatives have a fault that they are easily oxidized to be decomposed and disappear before they show their fill activity, because their 2- or 3-carbon atom of indole ring is very active in plants.

Besides, previous roots-inducing agents of plants are used by powdering it directly onto the cut surface of stems or leaves, or by soaking or dipping the cut surface of stems or leaves into its solution diluted to the designated concentration with water. Then, every out stem or leaf must be powdered directly or soaked or dipped in the solution and they are planted in the cultivation soil in a plug. Therefore, this is a problem that the work cannot be performed smoothly and that it takes much time and it is inefficient.

The present invention has been made based upon such a subject, and we have found that spraying a water solution of esters of 4-chloroindole-3-acetic acid or 4-chloroindole-3-butyric acid onto the surface of leaves can induce roots of the above-mentioned plants without roots so as to make the plants take root efficiently, and have completed the invention. Although the mechanism of its action has not been clear yet, it is likely that the compound sprayed onto the surface of leaves may be absorbed via stomas of leaves and reach the action site through sieve tubes. Then, its action may be observed as an action to induce a differentiation into the original basis and an action to stimulate the growth of indefinite roots from the original basis continuously.

That is, the purpose of the present invention is to offer the convenient roots-inducing agent of plants capable of inducing roots of plants without roots made by a cutting into cultivation soil so as to make the plants take root efficiently and its treatment method.

A summary of the means to solve the above-mentioned subject adopted in the present invention is described in claims.

That is, the invention described in claim 1 is a summary of “a solution including a compound (or compounds) among those shown as in the following formula (Compound 3, in which R means one of alkyl- and allyl-groups of hydrogen, methyl, ethyl 1-propyl, 2-propyl, 1-butyl, isobutyl, 2-butyl, R)-2-butyl, (S)-2-butyl, tert-butyl, and 1-pentyl.), and a roots-inducing agent of plants characterized by its ability to induce roots of plants without roots made by a cutting into cultivation soil through its spraying onto the surface of the leaves”

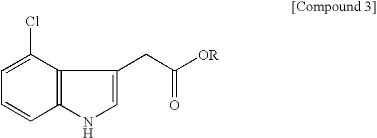

The invention described in claim 2 is a summary of “the roots-inducing agent of plants characterized by the concentration of the above compounds in the range of 10⁻⁷˜10⁻² M described in claim 1”.

The invention described in claim 3 is a summary of “the method to induce roots of plants without roots made by a cutting into cultivation soil through the spraying onto the surface of the leaves of the solution including a compound (or compounds) among those shown as in the following formula (Compound 4, in which R means one of alkyl and allyl-groups of hydrogen, methyl, ethyl, 1-propyl, 2-propyl, 1-butyl, isobutyl, 2-butyl, (R)-2-butyl, (S)-2-butyl, tert-butyl, and 1-pentyl.)”.

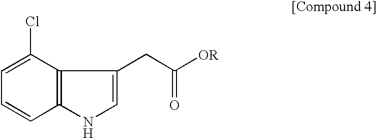

The invention described in claim 4 is a summary of “the method to induce roots of plants without roots characterized by the concentration of the above compounds in the range of 10⁻⁷˜10⁻² M described in claim 3”.

The roots-inducing agent of plants described in claims 1 and 2 can be used by spraying directly onto the surface of leaves of plants without roots such as the cut stems or leaves planted into cultivation soil in plug, not so as that previous roots-inducing agents or plants are used by soaking or dipping the every cut surface individually and they are planted in the cultivation soil.

Furthermore, the present agent can be used by spraying with a sprayer carried on the back, a sprinkler equipped in a cultivation house, or a pipe to circulate water, and the work can be performed smoothly and efficiently so as to save the working time.

Consequently, by the method to induce roots of plants described in claims 3 and 4, the plants without roots can be planted into cultivation soil in plug and sprayed directly, not so as that every cut surface must be soaked or dipped individually according to the previous method. Therefore, the work can be performed smoothly and efficiently so as to save the working time.

### DETAILED DESCRIPTION OF THE PREFERRED EMBODIMENTS

Although the roots-inducing agent of plants in the present invention is explained in detail using the embodiments, the present invention is not limited by the following embodiments.

The optimum concentration of the roots-inducing agent of plants in the present invention can be used in the range of 10⁻⁷˜10⁻² M, although it is varied depending on the kind of plants. The more diluted solution than the concentration of 1×10⁻⁷ M has a tendency to be insufficient to induce the roots of plants. The solution at the higher concentration than 1×10⁻² M may not show the roots-inducing activity depending on the kind of plants. This range of the concentrations is prescribed only for convenience and it is favorable that the concentration is decided by the preliminary investigation of the optimum concentration for the individual kind of plants.

The present roots-inducing agent of plants can be used as an individual solution according to the purpose of its use. It can also be used by dilution frown the condensed solution with water to the prescribed concentration at use. Furthermore, it condensed solution with water to the prescribed concentration at use. Furthermore, it can be dissolved with auxiliary solvent such as alcohol and then diluted with water to the prescribed concentration. It can also be used as a milky liquid made by mixing with a mixture of polyoxyethylene alkylphenyl ether and calcium alkylbenzenesulfonate after its dilution with an organic solvent such as xylene, and then diluted with water to the prescribed concentration.

Furthermore, it can be used after mixing with growth promoters such as sodium dodecylbenzenesulfonate and nonyl phenyl ether, which are commonly used agricultural chemicals, in order to promote or to stabilize its action. Also, it can be mixed with other agricultural chemicals, fertilizers, spreading agents, and plant growth regulators on the market.

The present roots-inducing agent of plants can be adapted to not only crops such as grain potatoes, vegetables, mulberry, beet, and sugarcane but also various plants such as trees including pine, Japanese cedar, Japanese cypress, and hiba, flowers, and decorative plants.

EMBODIMENT 1. Roots-inducing and fixation-stimulating actions in cuttings of violets

Seedlings of violets were used in the experiment. The lower part of the seedlings of violets was cut and cuttings of violets without roots were prepared. Each cutting of violets was planted into cultivation soil in a plug tray and supplied water sufficiently.

The plug trays were lined up on the working stand in a green house where the temperature was controlled at 25-33 (C. The water solution of 4-chloroindole-3-acetic acid (20 ppm) was sprayed in a misty manner through an atomizer onto the surface of leaves so that the surface got wet uniformly (once).

Then, the plants were grew for 38 days with 1-2 times water supply every other day, and numbers of the cuttings with and without roots-induction and of the dead cuttings. In the control, the cuttings were sprayed only water instead of 4-chloroindole-3-acetic acid solution and grew under the same conditions as those described above. The results are shown in Table 1

TABLE 1

| | Total | Cuttings with | Cuttings without | Dead |
|---|---|---|---|---|
| | cuttings | roots-induction | roots-induction | cuttings |
| | (%) | (%) | (%) | (%) |
| Treatment | 93 | 74 | 6 | 13 |
| (4-Cl-iAA) | (100) | (80) | (6) | (14) |
| Control | 101 | 27 | 1 | 73 |
| | (100) | (27) | (I) | (72) |

In control group, 72 cuttings of violets were dead among 101 plants, and only 27 cuttings (27%/) exhibited roots-induction. On the other hand, in treatment group, 74 cuttings (80%) among 93 plants exhibited roots-induction and only 13 cuttings were dead. Thus, roots-inducing and fixation-stimulating actions of 4-chloroindole-3-acetic acid were extremely prominent.

Furthermore, roots-induction was observed around 3 days in treatment group, whereas it was observed only after 7 days in control group, based on the results that roots were checked by digging up at random (No statistical analysis).

The similar results were obtained when the water solution of 4-chloroindole-3-acetic acid including 1000 fold diluted spreading agent (commercial name: Nitten) was treated in treatment group and its roots-inducing and fixation-stimulating actions were compared with 1000-fold diluted spreading agent (commercial name: Nitten) alone in control group.

Embodiment 2. Roots-inducing and fixation-stimulating actions in cut stems of chrysanthemums

Stems of chrysanthemums were cut out by 5 cm from the part at 5-10 cm from the top to prepare cuttings with 2 leaves. The water solution of the tested compound (5 ppm) was sprayed once in a misty manner through an mascot spray onto the surface of leaves so that the surface got wet uniformly for each 8 cuttings. The cuttings in the pots were grew in a cabinet where the temperature was controlled in the range of 15 (C at lowest at night to 30 (C at highest in the daytime. Water was supplied appropriately according to the extent of dryness of soil during the cultivation of plants.

On the 50th day after the tested compound was sprayed, roots-induction of each cutting was checked by diggings up, and its extent was shown as an index for each rank. The results are shown in Table 2.

TABLE 2

| | Index for roots-induction | | | | | | | | |
|---|---|---|---|---|---|---|---|---|---|
| Treatment | 1 | 2 | 3 | 4 | 5 | 6 | 7 | 8 | Total indexes |
| Non-treatment | 2 | 1 | 1 | 1 | 1 | 1 | 0 | 0 | 7 |
| 4-Cl-IAA | 3 | 2 | 2 | 2 | 2 | 2 | 0 | 0 | 13 |
| 4-Cl-IAA Me | 3 | 3 | 3 | 2 | 2 | 2 | 0 | 0 | 15 |
| 4-Cl-IAA Et | 3 | 3 | 3 | 3 | 3 | 2 | 1 | 0 | 18 |
| 4-Cl-IAA I-Pr | 3 | 3 | 2 | 2 | 2 | 2 | 1 | 1 | 16 |
| 4-Cl-IAA 2-Pr | 2 | 2 | 2 | 2 | 2 | 1 | 0 | 0 | 11 |
| 4-Cl-IAA Ally | 3 | 3 | 2 | 2 | 2 | 1 | 1 | 0 | 14 |
| 4-Cl-IAA 1-Bu | 2 | 2 | 2 | 2 | 1 | 1 | 0 | 0 | 10 |
| 4-Cl-IAA 2-Bu | 2 | 2 | 2 | 2 | 1 | 1 | 0 | 0 | 10 |
| 4-Cl-IAA isoBu | 2 | 2 | 2 | 1 | 1 | 0 | 0 | 0 | 8 |
| 4-Cl-IAA pentyl | 2 | 2 | 2 | 2 | 1 | 1 | 0 | 0 | 10 |

Extent of roots-induction 3: The cuttings with 20 or more roots per a cutting

Extent of roots-induction 2: The cuttings with 10-19 roots per a cutting

Extent of roots-induction 1: The cuttings with 5-9 roots per a cutting

Extent of roots-induction 0; The cuttings with less than 4 roots (including no roots)

The roots-inducing agent of plants including the compound such as 4-chloroindole-3-acetic acid and its esters as an active component can be used by spraying directly onto the surface of leaves of plants without roots such as the cut stems or leaves planted into cultivation soil in plug, not so as that the cut surface of each plant was soaked or dipped previously and it is planted in the cultivation soil. Furthermore, it can be used by spraying with a sprayer carried on thc back, a sprinkler equipped in a cultivation house, or a pipe to circulate water, after the plants without roots are planted in cultivation soil in a plug. Therefore, the work can be performed smoothly and efficiently so as to save the working time.

Consequently, since it is used by spraying the directly in a misty manner onto the surface of leaves, it has an advantage of the convenience. Also, it can induce roots of the plants without roots and fixed them efficiently. That is, a reliable roots-inducing agent of plants and a certain way to induce roots of plants without roots can be submitted. Thus, there is a superior advantage for the practical effect.

What is claimed is;

1. A solution including a compound (or compounds) among those shown as in the following, formula ([compound 1], in which R means one of alkyl- and allyl-groups of hydrogen methyl, ethyl, 1-propyl, 2-propyl, 1-butyl, isobutyl, 2-butyl, (R)-2-butyl, (S)-2-butyl, tert-butyl, and 1-pentyl.), and a roots-inducing agent of plants characterized by its ability to induce roots of plants without roots made by a cutting into cultivation soil through its spraying onto the surface of leaves.

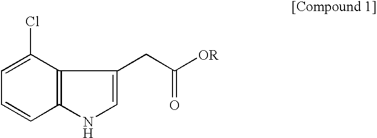

2. The roots-inducing agent of plants characterized by the concentration of the above compounds in the range of 10⁻⁷˜10⁻² M described in claim 1.

3. A method to induce roots of plants without roots made by a cutting into cultivation soil through the spraying onto the surface of leaves the solution including a compound (or compounds) among those shown as in the following formula ([Compound 2], in which R means one of alkyl- and allyl-groups of hydrogen, methyl, ethyl 1-propyl, 2-propyl, 1-butyl, isobutyl, 2-butyl, (R)2-butyl, (S)-2-butyl, tert-butyl, and 1-pentyl.).

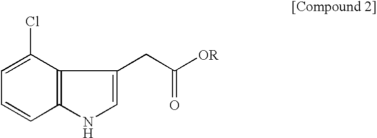

4. The method to induce roots of plants without roots characterized by the concentration of the above compounds in the range of 10⁻⁷˜10⁻² M described in claim 3.
